(19) United States
(12) Patent Application Publication
(10) Pub. No.: US 2021/0227410 A1
(43) Pub. Date: Jul. 22, 2021

(54) PHYSICAL DOWNLINK CONTROL CHANNEL (PDCCH) MONITORING REDUCTION FOR SERVING CELL IN CARRIER AGGREGATION (CA)

(71) Applicant: QUALCOMM Incorporated, San Diego, CA (US)

(72) Inventors: Huilin Xu, San Diego, CA (US); Peter Pui Lok Ang, San Diego, CA (US); Seyedkianoush Hosseini, San Diego, CA (US); Krishna Kiran Mukkavilli, San Diego, CA (US); Hung Dinh Ly, San Diego, CA (US); Punyaslok Purkayastha, San Diego, CA (US); Yi Huang, San Diego, CA (US); Jing Lei, San Diego, CA (US)

(21) Appl. No.: 17/148,544

(22) Filed: Jan. 13, 2021

Related U.S. Application Data
(60) Provisional application No. 62/961,962, filed on Jan. 16, 2020.

(51) Int. Cl. H04W 24/08; H04W 72/12

(52) U.S. Cl. CPC H04W 24/08; H04W 72/1263

(57) ABSTRACT

The present disclosure relates to physical downlink control channel (PDCCH) monitoring. For example, a method of wireless communication includes determining, by a user equipment (UE), whether one or more conditions is satisfied. The method also include performing, by the UE, physical downlink control channel (PDCCH) monitoring associated with a first cell based on a determination that the one or more conditions is satisfied. Other aspects and features are also claimed and described.

### CROSS-REFERENCE TO RELATED APPLICATIONS

This application claims the benefit of U.S. Provisional Patent Application No. 62/961,962, entitled, “PHYSICAL DOWNLINK CONTROL CHANNEL (PDCCH) MONITORING REDUCTION FOR SERVING CELL IN CARRIER AGGREGATION (CA),” filed on Jan. 16, 2020, which is expressly incorporated by reference herein in its entirety.

### TECHNICAL FIELD

Aspects of the present disclosure relate generally to wireless communication systems, and more particularly, but without limitation, to physical downlink control channel (PDCCH) monitoring.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY

In one aspect of the disclosure, according to some aspects, a method of wireless communication includes determining, by a user equipment (UE), whether one or more conditions is satisfied. The method also includes performing, by the UE, physical downlink control channel (PDCCH) monitoring associated with a first cell based on a determination that the one or more conditions is satisfied.

In an additional aspect of the disclosure, an apparatus configured for wireless communication includes means for determining, by a user equipment (UE), whether one or more conditions is satisfied. The apparatus also includes means for performing, by the UE, physical downlink control channel (PDCCH) monitoring associated with a first cell based on a determination that the one or more conditions is satisfied.

In an additional aspect of the disclosure, a non-transitory computer-readable medium having program code recorded thereon. The program code further includes code to determine, by a user equipment (UE), whether one or more conditions is satisfied, and perform, by the UE, physical downlink control channel (PDCCH) monitoring associated with a first cell based on a determination that the one or more conditions is satisfied.

In an additional aspect of the disclosure, an apparatus configured for wireless communication is disclosed. The apparatus includes at least one processor, and a memory coupled to the processor. The processor is configured to determine, by a user equipment (UE), whether one or more conditions is satisfied, and perform, by the UE, physical downlink control channel (PDCCH) monitoring associated with a first cell based on a determination that the one or more conditions is satisfied.

In an additional aspect of the disclosure, an apparatus configured for wireless communication is disclosed. The apparatus includes an interface configured for wireless communication and a processor system coupled to the interface. The processor system is configured to determine, by a user equipment (UE), whether one or more conditions is satisfied, and perform, by the UE, physical downlink control channel (PDCCH) monitoring associated with a first cell based on a determination that the one or more conditions is satisfied.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some aspects.

FIG. 2 is a block diagram conceptually illustrating a design of a base station and a UE configured according to some aspects.

FIG. 3 is a block diagram illustrating a wireless communication system with communications that utilize physical downlink control channel (PDCCH) monitoring in accordance with some aspects of the present disclosure.

FIG. 4 is a flow diagram illustrating example blocks executed by a UE according to some aspects.

FIG. 5 is a block diagram conceptually illustrating an example design of a UE according to some aspects of the present disclosure.

FIG. 6 is a block diagram conceptually illustrating an example design of a base station according to some aspects of the present disclosure.

The Appendix provides further details regarding various embodiments of this disclosure and the subject matter therein forms a part of the specification of this application.

### DETAILED DESCRIPTION

The detailed description set forth below, in connection with the appended drawings and appendix, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In the present disclosure, various aspects and techniques regarding physical downlink control channel (PDCCH) monitoring are disclosed. The various aspects and techniques described herein may include or relate to how to reduce PDCCH monitoring for a serving cell in carrier aggregation (CA). For example, as described further herein, a UE may move monitoring from a cell, such as a PCell or a SCell, to another cell. For example, PDCCHs to be monitored may be moved. Such PDCCHs may belong to DCI for broadcast data, UE group common control information, or unicast data, as illustrative, non-limiting examples. In some implementations, as described further herein, a UE may be configured to determine whether one or more conditions is satisfied and perform physical downlink control channel (PDCCH) monitoring associated with a first cell based on a determination that the one or more conditions is satisfied. For example, the UE may perform PDCCH monitoring (for the first cell) in a second cell such that PDCCH monitoring in the first cell is reduced.

This disclosure relates generally to providing or participating in communication as between two or more wireless devices in one or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as GSM. 3GPP defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with Universal Terrestrial Radio Access Networks (UTRANs) in the case of a UMTS/GSM network. An operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to exemplary LTE implementations or in an LTE-centric way, and LTE terminology may be used as illustrative examples in portions of the description below; however, the description is not intended to be limited to LTE applications. Indeed, the present disclosure is concerned with shared access to wireless spectrum between networks using different radio access technologies or radio air interfaces, such as those of 5G NR.

Moreover, it should be understood that, in operation, wireless communication networks adapted according to the concepts herein may operate with any combination of licensed or unlicensed spectrum depending on loading and availability. Accordingly, it will be apparent to one of skill in the art that the systems, apparatus and methods described herein may be applied to other communications systems and applications than the particular examples provided.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

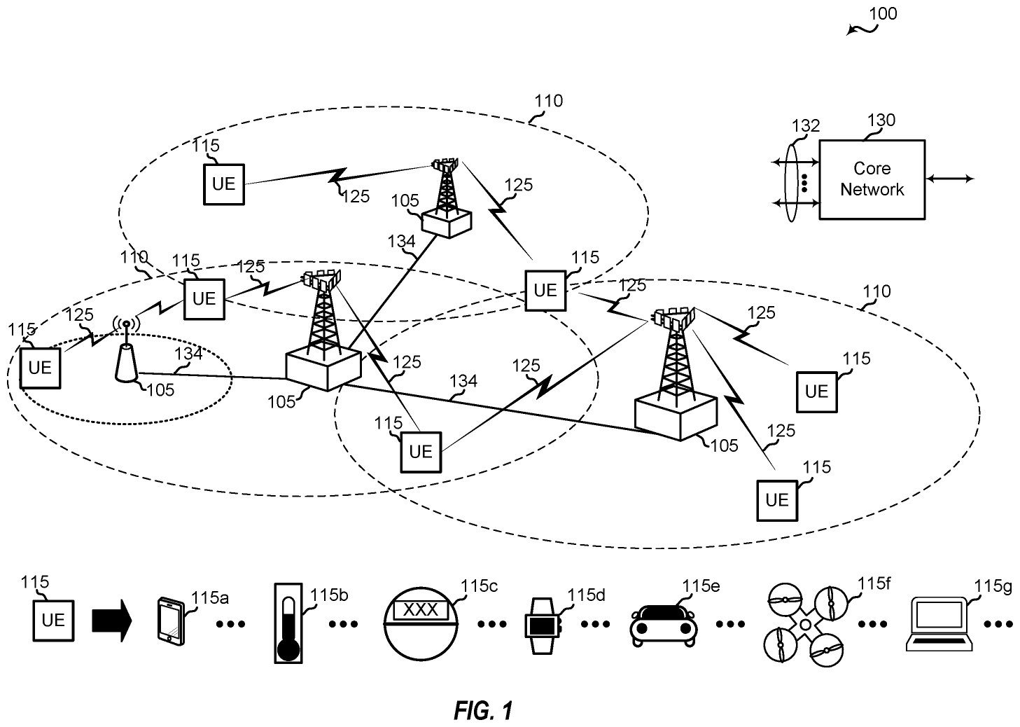

FIG. 1 is a block diagram illustrating an example of a wireless communications system 100 that supports physical downlink control channel (PDCCH) monitoring. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or NR network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be referred to as forward link transmissions while uplink transmissions may also be referred to as reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and, therefore, provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone (UE 115a), a personal digital assistant (PDA), a wearable device (UE 115d), a tablet computer, a laptop computer (UE 115g), or a personal computer. In some examples, a UE 115 may also refer to a wireless local loop (WLL) station, an Internet-of-things (IoT) device, an Internet-of-everything (IoE) device, an MTC device, or the like, which may be implemented in various articles such as appliances, vehicles (UE 115e and UE 1150, meters (UE 115b and UE 115c), or the like.

Some UEs 115, such as MTC or IoT devices, may be low cost or low complexity devices, and may provide for automated communication between machines (e.g., via machine-to-machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In other cases, UEs 115 may be designed to support critical functions (e.g., mission critical functions), and a wireless communications system 100 may be configured to provide ultra-reliable communications for these functions.

In certain cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 may facilitate the scheduling of resources for D2D communications. In other cases, D2D communications may be carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

Wireless communications system 100 may include operations by different network operating entities (e.g., network operators), in which each network operator may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In various implementations, wireless communications system 100 may use both licensed and unlicensed radio frequency spectrum bands. For example, wireless communications system 100 may employ license assisted access (LAA), LTE-unlicensed (LTE-U) radio access technology, or NR technology in an unlicensed band (NR-U), such as the 5 GHz ISM band. In some cases, UE 115 and base station 105 of the wireless communications system 100 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available.

A CCA may include an energy detection procedure to determine whether there are any other active transmissions on the shared channel. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include message detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In certain implementations, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In additional cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot, while in other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier,” as may be used herein, refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In certain instances, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum, such as NR-shared spectrum (NR-SS)). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In additional cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

For New Radio (NR) Rel. 15 and 16, Primary Cell (Pcell) is only allowed to be scheduled by itself when cross-carrier scheduling is configured for Carrier Aggregation (CA). In such situations, a Secondary Cell (Scell) cannot schedule the PCell. It is noted that PCell can refer to primary cell of a Master Cell Group (MCG) and a primary secondary cell of Secondary Cell Group (SCG). In CA, UE 115 can be configured to communicate with more than one cell.

Cross carrier scheduling of data may rely on Carrier Indicator Field (CIF) which may be available in non-fallback Downlink Control Information (DCIs) (DCI 0_1 for Uplink (UL) and DCI 1_1 for Downlink (DL)). The CIF indicates the identity of the serving cell where data is transmitted or received, such as which cell is scheduled by the DCI.

To facilitate cross-carrier scheduling, network (e.g., 130) may configure a search space set in the active Bandwidth Part (BWP) (also referred to as a Carrier Bandwidth Part) of the scheduled cell that has the same search space identifier (ID) as that of a search space set in the active BWP of the scheduling cell. Search space occasions for PDCCH monitoring for the scheduled cell can be determined by the search space set configuration of the scheduling cell, number of PDCCH candidates for each aggregation level for the scheduled cell are determined by the search space set configuration of the scheduled cell.

Control information of certain operation (i.e., slot format determination, pre-emption, power control for Physical Uplink Shared Channel (PUSCH)/Physical Uplink Control Channel (PUCCH), Sounding Reference Signal (SRS) switching) can be included in same Downlink Control Information (DCI) for multiple serving cells based on the cell index associated with each cell in the DCI.

Radio Network Temporary Identifiers (RNTIs) can be used to differentiate/identify a connected UE in the cell, a specific radio channel, a group of UEs in case of paging, a group of UEs for which power control is issued by the eNB, system information transmitted for all the UEs by 5G gNB. For example, RNTI may be a 16-bit identifier and its value depends on type of RNTI. RNTIs defined for New Radio include:
SI-RNTI: System Information-Radio Network Temporary Identifier;
RA-RNTI: Random Access-Radio Network Temporary Identifier;
TC-RNTI: Temporary Cell-Radio Network Temporary Identifier;
P-RNTI: Paging-Radio Network Temporary Identifier;
SFI-RNTI: Slot Format Indication-Radio Network Temporary Identifier;
INT-RNTI: Interruption-Radio Network Temporary Identifier;
TPC-PUSCH-RNTI: Transmit Power Control-Physical Uplink Shared Channel-Radio Network Temporary Identifier;
TPC-PUCCH-RNTI: Transmit Power Control-Physical Uplink Control Channel-Radio Network Temporary Identifier;
TPC-SRS-RNTI: Transmit Power Control-Sounding Reference Signal-Radio Network Temporary Identifier;
C-RNTI: Cell-Radio Network Temporary Identifier;
MCS-C-RNTI: Modulation Coding Scheme-Cell-Radio Network Temporary Identifier;
CS-RNTI: Configured Scheduling-Radio Network Temporary Identifier; and
SP-CSI-RNTI: Semi-Persistent-Channel State Information-Radio Network Temporary Identifier.

Referring to TABLE 1 below, different RNTIs used to scramble DCIs are indicated based on usage, type of search space (SS) set, DCI format, whether typically used only in PCell, whether typically used only in MCG, and whether typically can carry control info for another cell. It is noted that for DCIs that are typically only received in PCell, the related data is also typically scheduled in PCell. It is further noted that a USS typically contains either fallback DCI (0_0, 1_0) or non-fallback DCI (0_1/1_1), but not both.

TABLE 1

| | | | | | | Can carry control |
|---|---|---|---|---|---|---|
| RNTI that scrambles | | Type of Search | DCI | Only in | Only in | info for another |
| the DCI | Usage | Space (SS) set | Format | PCell? | MCG? | cell? |
| SI-RNTI | System | Type0- | 1_0 | Yes | Yes | No |
| | Information | PDCCH | | | | |
| | Block 1 | Common | | | | |
| | (SIB1) | Search Space | | | | |
| | reception | (CSS) | | | | |
| SI-RNTI | Other | Type0A- | 1_0 | Yes | Yes | No |
| | System | PDCCH | | | | |
| | Information | CSS | | | | |
| | (OSI) | | | | | |
| | reception | | | | | |
| RA-RNTI | Random | Type1- | 0_0 | Yes | No | No |
| TC-RNTI | access | PDCCH | (only for | | | |
| | | CSS | TC-RNTI), | | | |
| | | | 1_0 | | | |
| P-RNTI | Paging | Type2- | 1_0 | Yes | Yes | No |
| | message | PDCCH | | | | |
| | | CSS | | | | |
| SFI-RNTI, | UE group | Type3- | 2_0, 2_1, | Yes | No | Yes |
| INT-RNTI, | common | PDCCH | 2_2, 2_2, | | | |
| TPC-PUSCH-RNTI, | control for | CSS | 2_3 | | | |
| TPC-PUCCH-RNTI, | multiple | | respectively | | | |
| or TPC-SRS-RNTI | serving cells | | | | | |
| C-RNTI, | UE unicast | Type3- | 0_0, 1_0 | No | No | No |
| MCS-C-RNTI, | data | PDCCH | | | | |
| or CS-RNTI | | CSS | | | | |
| C-RNTI, | UE unicast | UE Specific | 0_0, 1_0 | No | No | No |
| MSC-C-RNTI, | data | Search Space | | | | |
| or CS-RNTI | | (USS) | | | | |
| C-RNTI | UE unicast | USS | 0_1, 1_1 | No | No | Yes |
| MCS-C-RNTI | data | | (not for | | | |
| SP-CSI-RNTI, | | | SP-CSI- | | | |
| or CS-RNTI | | | RNTI) | | | |

In dynamic spectrum sharing (DSS), two Radio Access Technologies (RATs) (Long Term Evolution (LTE) and NR) share common bandwidth. If NR PCell is within the DSS bandwidth, resource that is available for downlink control information for the PCell is less than a non DSS scenario. As shown in TABLE 1, certain DCIs and scheduled data is typically only be received in PCell. To ensure that downlink control information transmission is not impacted by reduced effective spectral resource due to the sharing with LTE, resource used for DCI transmission in PCell may need to be reduced.

One way is to move PDCCHs that are typically used monitored in PCell to another cell (i.e., SCells). For example, as shown in the TABLE 1, these PDCCHs may belong to DCI for following categories: broadcast data that is only received in PCell, UE group common control information, unicast data for the PCell that is scheduled by fallback DCIs (0-0, 1-0) or non-fallback DCIs (0-1, 1-1), or unicast data for the other cells that is scheduled by non-fallback DCIs based on cross-carrier scheduling. Moving PDCCHs that are typically used monitored in PCell to another cell may reduce PDCCH monitoring in PCell, such as PDCCH monitoring in PCell within DSS bandwidth. Additionally, or alternatively, to reduce PDCCH monitoring in PCell, search space set configuration and rules for PDCCH monitoring may be adjusted and/or applied, as described further herein. For example, to reduce PCell PDCCH monitoring in DSS bandwidth, cross-carrier scheduling by PDCCH in the PCell for data that is scheduled in the other cells may be disabled. In some implementations, disabling cross-carrier scheduling may be applied to any serving cell that collides with DSS bandwidth no matter it is a PCell or not. By this proposal, a serving cell in DSS bandwidth will only schedules data for itself but does not cross-carrier data for any other cell. Additionally, or alternatively, when a cell overlaps with the DSS bandwidth, cross-carrier scheduling based on PDCCH in another cell may be used to schedule data for the cell. It is noted that although one or more techniques herein are described in the context of DSS or PCell, the one or more techniques may be applied in other contexts.

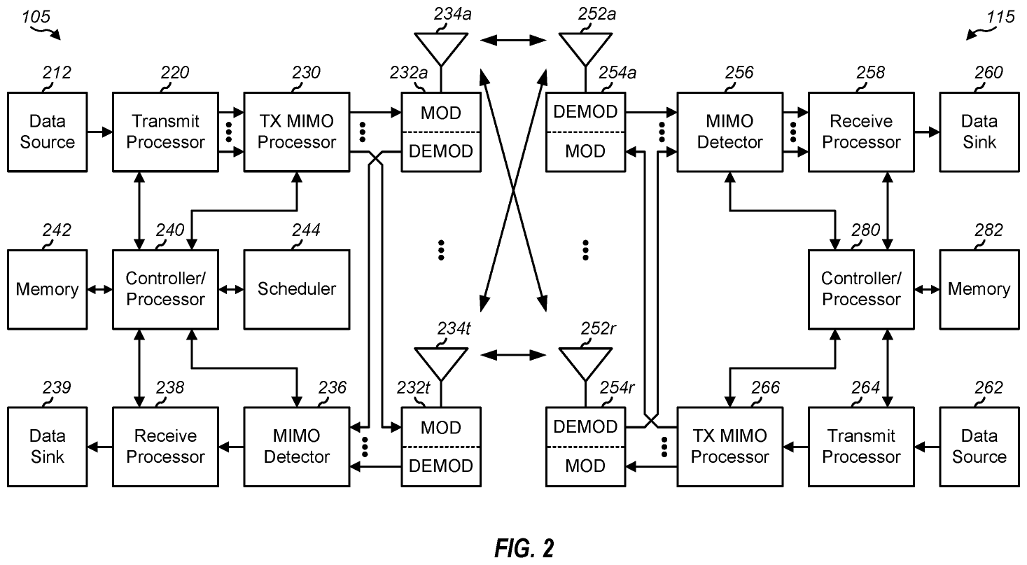

FIG. 2 shows a block diagram of a design of a base station 105 and a UE 115, which may be one of the base station and one of the UEs in FIG. 1. As shown in FIG. 2, base station 105 may be equipped with antennas 234a through 234t, and UE 115 may be equipped with antennas 252a through 252r for facilitating wireless communications.

At base station 105, a transmit processor 220 may receive data from a data source 212 and control information from a controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

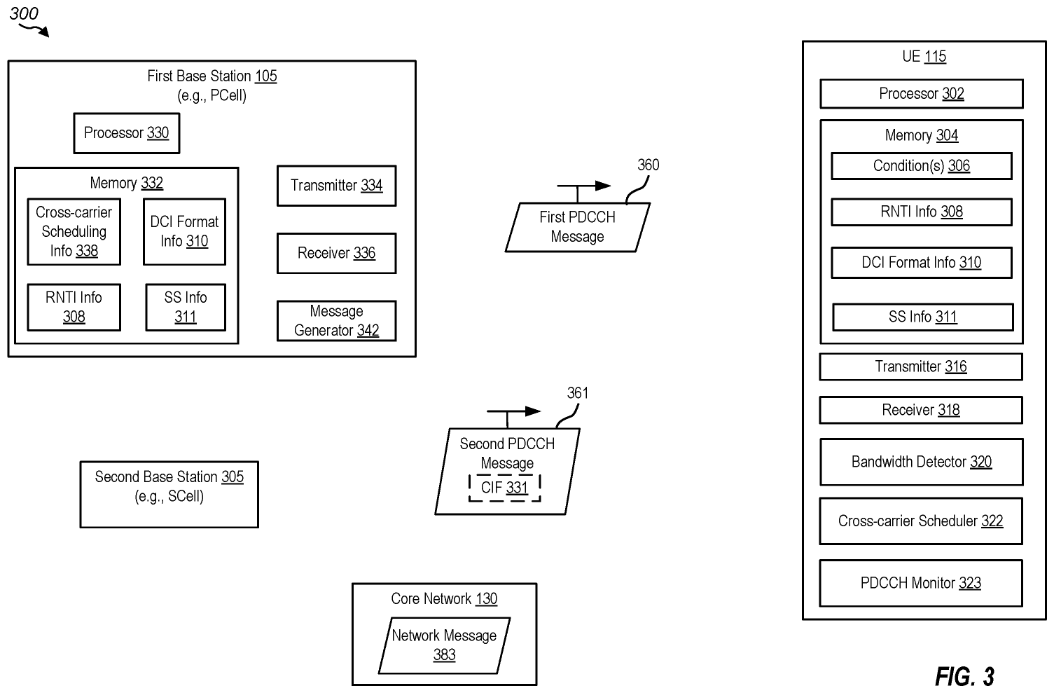

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIG. 3, 4, or 5, and/or other processes for the techniques described herein. The memories 242 and 282 may store data and program codes for the base station 105 and the UE 115, respectively. A scheduler 244 may schedule UEs for data transmission on the downlink and/or uplink.

FIG. 3 is a block diagram of an example wireless communications system 300 to utilize physical downlink control channel (PDCCH) monitoring. In some examples, wireless communications system 300 may implement aspects of wireless communication system 100. For example, wireless communications system 300 may include UE 115, one or more base stations, such as a first base station 105 and a second base station 305, and core network 130. Although one UE and two base station are illustrated, in other implementations, wireless communications system 300 may include multiple UEs 115, a single base station 105 or more than two base stations 105, or both.

UE 115 can include a variety of components (e.g., structural, hardware components) used for carrying out one or more functions described herein. For example, these components can include a processor 302, a memory 304, a transmitter 316, a receiver 318, a bandwidth detector 320, a cross-carrier scheduler 322, and a PDCCH monitor 323. Processor 302 may be configured to execute instructions stored at memory 304 to perform the operations described herein. In some implementations, processor 302 includes or corresponds to controller/processor 280, and memory 304 includes or corresponds to memory 282. In addition to the instructions stored at memory 304, memory 304 may be configured to store one or more conditions 306, RNTI information 308, DCI format information 310, and SS information 311.

The one or more conditions 306 may include or correspond to conditions and/or rules to enable UE 115 to reduce PDCCH monitoring of a cell, such as a PCell or SCell, as describe further herein. The RNTI information 308 may include or identify one or more RNTIs. The DCI format information 310 may include or identify one or more DCI formats. For example, the one or more DCI formats may include:
DCI 0_0 and DCI 1_0 for fallback DCIs;
DCI 0_1 and DCI, 1_1 for non-fallback DCIs;
DCI 2_0 for notifying the slot format;
DCI 2_1 for notifying the Physical Resource Block(s) (PRB(s)) and Orthogonal Frequency Division Multiplexing (OFDM) symbol(s) where UE may assume no transmission is intended for the UE;
DCI 2_2 for the transmission of TPC commands for PUCCH and PUSCH; and
DCI 2_3 for the transmission of a group of TPC commands for SRS transmissions.
   The SS information 311 may include or indicate a SS set index or a SS type, such as CSS or USS. One or more of conditions 306, RNTI information 308, DCI format information 310, and SS information 311 may be determined or set based on a standard, or may be set or determined by a network (e.g., 130). When set or determined by the network, UE 115 may receive such information via a network message 383.

Transmitter 316 is configured to transmit data to one or more other devices, and receiver 318 is configured to receive data from one or more other devices. For example, transmitter 316 may transmit data, and receiver 318 may receive data, via a wireless network. In some implementations, transmitter 316 and receiver 318 may be replaced with a transceiver. Additionally, or alternatively, transmitter 316, receiver 318, or both may include or correspond to one or more components of UE 115 described with reference to FIG. 2.

Bandwidth detector 320 is configured to determine whether a bandwidth, such as a bandwidth of a cell (e.g., a base station), at least partially overlaps with a DSS bandwidth. Cross-carrier scheduler 322 is configured to perform and/or coordinate cross-carrier scheduling operations. PDCCH monitor 323 is configured to perform PDCCH monitoring for/of one or more cells (e.g., one or more base stations).

Base station 105 includes a processor 330, a memory 332, a transmitter 334, a receiver 336, and a message generator 342. Processor 330 may be configured to execute instructions stored at memory 332 to perform the operations described herein. In some implementations, processor 330 includes or corresponds to controller/processor 240, and memory 332 includes or corresponds to memory 242. Memory 3332 may include cross-carrier scheduling information 338, RNTI information 308, DCI format information 310, and SS information 311. Cross-carrier scheduling information 338 may be configured to enable cross carrier scheduling operations associated with one or more base stations (e.g., 105, 305). Message generator 342 is configured is configured to generate one or more PDCCH messages.

Transmitter 334 is configured to transmit data to one or more other devices, and receiver 336 is configured to receive data from one or more other devices. For example, transmitter 334 may transmit data, and receiver 336 may receive data, via a wireless network. In some implementations, transmitter 334 and receiver 336 may be replaced with a transceiver. Additionally, or alternatively, transmitter 334, receiver, 336, or both may include or correspond to one or more components of base station 105 described with reference to FIG. 2.

Second base station 305 may include or correspond to first base station 105 such that second base station includes one or more components described with reference to first base station 105. In some implementations, first base station 105 is a PCell and second base station 305 is a SCell.

During operation of system 300, UE 115 may monitor PDCCH for first base station 105 (e.g., first cell). To illustrate, UE 115 may monitor one or more first PDCCH message(s) 360 from first base station 105. The one or more first PDCCH message(s) 360 may be generated by message generator 342 and transmitted via transmitter 334. Additionally, or alternatively, UE 115 may monitor PDCCH for first base station 105 in another cell (other than the first cell). To illustrate, UE may monitor one or more second PDCCH message(s) 361 from second base station 305 (e.g., second cell). In some implementations, second PDCCH message 361 may include a CIF 331 to enable UE 115 to determine that second PDCCH message 361 from second base station 305 include PDCCH for first base station 105.

In some implementations, UE 115 may perform PDCCH monitoring associated with the first cell (e.g., 105) based on a determination that the one or more conditions 306 is satisfied, as describe further herein. In some implementations, a determination that a condition (e.g., 306) is satisfied may be based on the first cell (e.g., 105) overlapping with the DSS bandwidth. Additionally, or alternatively, a determination that a condition (e.g., 306) is satisfied may be explicitly signaled by the network (e.g., 130) or implicitly determined by UE 115.

Performing the PDCCH monitoring (in the second cell for PDCCH for the first cell) may reduce PDCCH monitoring of the first cell for carrier aggregation, such as reducing PCell PDCCH monitoring in DSS bandwidth, as described herein. In some implementations, the first cell (e.g., 105) includes a primary cell or a secondary cell. When the first cell is the primary cell, the primary cell may include a primary cell of a master cell group (MCG) or a primary secondary cell of a secondary cell group (SCG).

In some implementations, reducing PCell PDCCH monitoring in the DSS bandwidth may include disabling cross-carrier scheduling by PDCCH in the PCell (e.g., 105) for data that is scheduled in the other cells. It is noted that disabling cross-carrier scheduling by PDCCH may be implemented for any serving cell (e.g., 105 or 305) that collides with the DSS bandwidth independent of whether or not the cell is a PCell. By disabling the cross-carrier scheduling, a serving cell in the DSS bandwidth schedule data for itself, but may not cross-carrier data for another cell. To illustrate, disabling cross-carrier scheduling by PDCCH may result in the service cell in the DSS bandwidth only scheduling data for itself and not scheduling cross-carrier data for any other cell.

To illustrate, based on a first condition of the one or more conditions 306 being satisfied, the cell (e.g., a PCell or Scell—independently for each cell) corresponding to base station 105, 305, cross-carrier scheduling of data in the other cells by PDCCHs received in the cell is not allowed. The cell does not allow cross-carrier scheduling of data independent of whether or not other cells allow cross-carrier scheduling of data. In some implementations, the first condition is satisfied when the cell overlaps with the DSS bandwidth. Not allowing cross-carrier scheduling of data in the other cells by PDCCHs received in the cell may be implemented in a network independent of signaling from the network (e.g., 130). To illustrate, not allowing cross-carrier scheduling of data in the other cells by PDCCHs received in the cell may be implemented per a standard.

In some implementations, to reduce PDCCH monitoring, cross-carrier scheduling of data for the cell by PDCCHs monitored in another cell may be used. In some such implementations, cross-carrier scheduling may be supported by non-fallback DCIs (i.e., 0_1, 1_1) which uses CIF to indicate the cell where data is transmitted. Cross-carrier scheduling of data for the cell by PDCCHs monitored in another cell can move non-fallback DCI monitoring (by UE 115) from the cell in the DSS bandwidth to another cell which is not in DSS bandwidth.

To illustrate, based on a second condition of the one or more conditions 306 being satisfied, the cell (e.g, a PCell or Scell—independently for each cell) corresponding to base station 105, 305, cross-carrier scheduling based on PDCCH in another cell to schedule data for the cell is used. It is noted that, when the second condition is present for a PCell, fallback DCIs and other DCIS for the Pcell may still be received in the PCell and, when the second condition is present for a SCell, fallback DCIs may still be received in the SCell. In some implementations, the second condition is satisfied when the cell overlaps with the DSS bandwidth.

In some implementations, to reduce PDCCH monitoring, group-common (GC) DCIs may be monitored and/or received in another cell. To illustrate, typically, GC DCIs are received by UE 115 in a PCell, such as a cell corresponding to base station 105. If the PCell overlaps with the DSS bandwidth, to further reduce PDCCH monitoring in PCell, UE 115 may monitor the GC DCIs in another cell (i.e., a SCell).

To illustrate, based on a third condition of the one or more conditions 306 being satisfied, the cell (e.g, a PCell) corresponding to base station 105, 305, one or more GC DCIs may be monitored in another cell. The GC DCIs may include: DCI 2_0 for notifying the slot format, DCI 2_1 for notifying the Physical Resource Block(s) (PRB(s)) and Orthogonal Frequency Division Multiplexing (OFDM) symbol(s) where UE may assume no transmission is intended for the UE, DCI 2_2 for the transmission of TPC commands for PUCCH and PUSCH, DCI 2_3 for the transmission of a group of TPC commands for SRS transmissions, or a combination thereof. Additionally, or alternatively, in some implementations, based on the third condition being satisfied, fallback DCI formats (0_0, 1_0) for the cell may be monitored in another cell. Additionally, or alternatively, in some implementations, based on the third condition being satisfied, DCIs in the CSS or USS for the cell may be monitored in another cell. In some implementations, the third condition is satisfied when the cell overlaps with the DSS bandwidth.

In some implementations, to reduce PDCCH monitoring, based on a fourth condition being met, fallback DCI formats (0_0, 1_0), such as DCI 0_0 and 1_0 for broadcast data for the cell (e.g, a PCell), may be monitored in another cell. For example, the DCIs may include: DCIs scrambled by SI-RNTI for SIB reception, DCIs scrambled by RA-RNTI and TC-RNTI for random access, DCIs scrambled by P-RNTI for paging, or a combination thereof. In some implementations, the fourth condition is satisfied when the cell overlaps with the DSS bandwidth.

In some implementations, to reduce PDCCH monitoring, based on a fifth condition being met, fallback DCI formats (0_0, 1_0), such as DCI 0_0 and 1_0 for unicast data for the cell (e.g, a PCell or SCell—independently for each cell), may be monitored in another cell. For example, the DCIs may include: DCIs scrambled by C-RNTI, MCS-C-RNTI, or CS-RNTI in CSS for unicast data scheduling, DCIs scrambled by C-RNTI, MCS-C-RNTI, or CS-RNTI in USS for unicast data scheduling, or a combination thereof.

In some implementations, to reduce PDCCH monitoring, based on a fifth condition being met, one or more (or all) DCIs configured in the CSS or USS for the cell (e.g, a PCell or SCell—independently for each cell) may be monitored in another cell.

It is noted that each of the second, third, fourth, fifth, and/or sixth conditions (or results of the condition being satisfied) is not limited to a DSS scenario (e.g., a cell overlapping with the DSS bandwidth. To illustrate, the result of the second-sixth conditions being satisfied may be performed in situations where the cell is that is not overlapping with DSS bandwidth.

Additionally, the second, third, fourth, fifth, and/or sixth conditions, for the condition may be considered in addition to the first condition. Accordingly, one or more operations may be performed based on the first condition being satisfied, and at least one additional operation may also be performed on the second, third, fourth, fifth, or sixth condition being satisfied. Additionally, or alternatively, for each of the second, third, fourth, fifth, and sixth conditions, the network (e.g., 130) may configure the search space set associated with the DCI in another cell. It is noted that frequency domain resource assignment field of the DCI may still be determined by active BWP bandwidth of the cell. In other implementations, for each of the second, third, fourth, fifth, and sixth conditions, the network (e.g., 130) may configure the search space set in the cell, but determines another cell where the DCI is monitored.

In some implementations, for the second, third, fourth, fifth, and/or sixth conditions, the other cell may be specified explicitly by the network. For example, the network may explicitly configure another cell where the DCI for the cell is monitored according to search space set configuration for the cell. To illustrate, the network may use or provide a dedicated indication of the other cell, or may reuse the scheduling cell of the cell where the cross-carrier scheduling DCI (i.e., non-fallback DCI with CIF) for the cell is monitored. In other implementations, the network may implicitly determine another cell to receive the DCI for the cell according to search space set configuration for the cell. In such implementations, the other cell may be determined based on (or as) the lowest ID cell other than the cell that is configured to the UE in the cell group, or the lowest ID cell other than the cell that is configured to the UE in the cell group that does not overlap with DSS bandwidth.

In some implementations, for the second, third, fourth, fifth, and/or sixth conditions, UE 115 is allowed to monitor DCIs for the cell in another cell (and these DCIs are not used by cross-carrier scheduling) or UE 115 is allowed to monitor some DCIs in itself and the other DCIs in another cell. In some such implementations, the network may explicitly indicate to UE 115 that any of the second, third, fourth, fifth, and/or sixth conditions is enabled and/or can be considered for the cell. To indicate to UE 115, the network may send a Radio Resource Control (RRC) message or a DCI that includes or provides an indication. Alternatively, the network may implicitly enable any of the second, third, fourth, fifth, and/or sixth conditions that is supported by NR for the cell as long as UE 115 is configured with DSS and the cell overlaps with DSS bandwidth.

Additionally, or alternatively, the UE 115 may need to be aware that the network has enabled and adopted or enabled certain conditions. For UE 115 to determine which DCIs for the cell are to be monitored in another cell, the network may explicitly configure the SS set index, the SS type (CSS or USS), the RNTI, or the DCI format associated with the DCI that UE monitors in another cell. Alternatively, the SS set index, SS type (CSS or USS), RNTI, or DCI format associated with the DCI that UE monitors in another cell may be specified or determined based on a standard.

Regarding the fifth consideration and/or the sixth condition, UE 115 may monitor fallback DCI (0-0, 1-0) scrambled by C-RNTI, MCS-C-RNTI, or CS-RNTI in another cell for unicast data in the cell. The DCI could be ambiguous with a fallback DCI monitored in another cell for unicast data in a third cell. The third cell may be the same cell as another cell, or the third cell may be a cell different cell than another cell whose fallback DCIs are also monitored in another cell. An ambiguous DCI means that UE 115 cannot determine which cell the decoded DCI belongs to if the same set of CCEs can be allocated to a DCI for the cell and a DCI for the third cell that are scrambled with the same RNTI, have the same DCI size and the same scrambling. Ambiguity can occur because the fallback DCI does not use CIF to indicate which cell the DCI is for. If an ambiguity condition occurs and/or is identified by UE 115, UE 115 may consider this as an error case, i.e., ambiguity is not expected by the UE and the DCI may be discarded. In some implementations, if an ambiguity condition occurs and/or is identified by UE 115, specific behavior by UE 115 may not be specified and UE 115 may be allowed to do anything—e.g., drop the DCI, assign the DCI to a particular cell, assign the DCI to a random cell, etc. In other implementations, if an ambiguity condition occurs and/or is identified by UE 115, UE 115 may assume the DCI belongs to one of the cell and the third cell based on priority rule. Multiple rules can be combined to uniquely determine which cell the DCI belongs to. For example, the DCI may be assigned to a PCell over an SCell, priority may be determined based on cell ID (e.g., lower cell ID has priority or higher cell ID has priority), priority may be determined based on SS type (e.g., CSS preferred over USS or USS preferred over CSS). In some implementations, to avoid or resolve an ambiguity, network may add a field to a DCI to indicate the cell to which the DCI is to be used for.

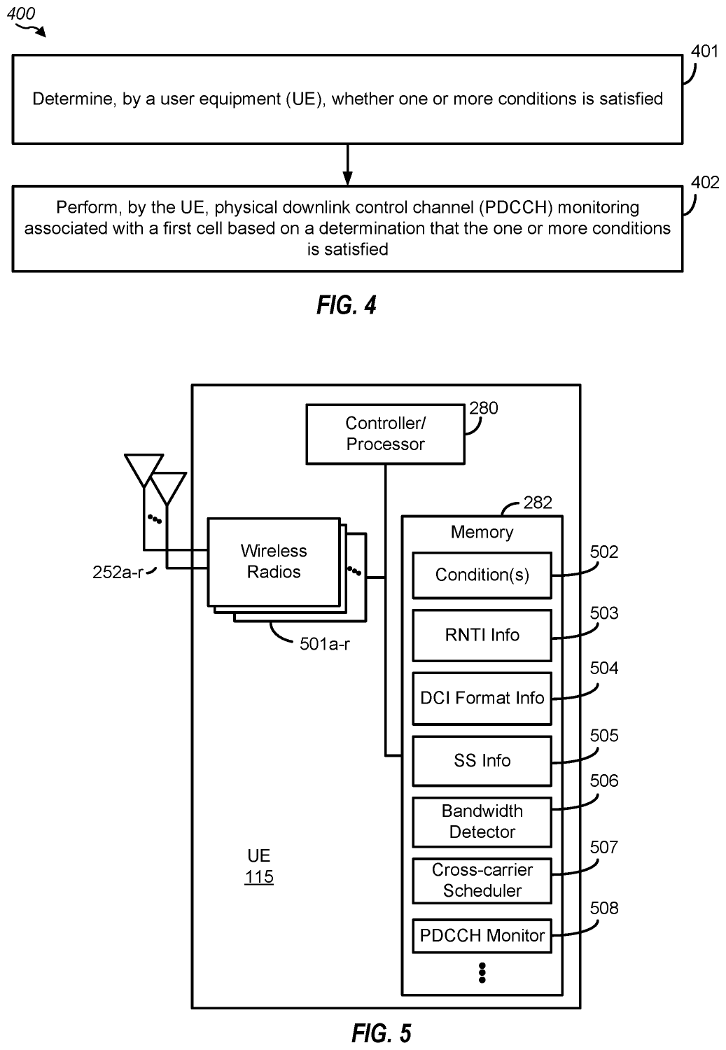

FIG. 4 is flow diagrams illustrating example methods performed by a UE for communication. For example, the example blocks may cause UE to perform PDCCH monitoring according to some aspects of the present disclosure. The example blocks will also be described with respect to UE 115 as illustrated in FIG. 5. FIG. 5 is a block diagram conceptually illustrating an example design of a UE configured to perform PDCCH monitoring according to one aspect of the present disclosure. UE 115 includes the structure, hardware, and components as illustrated for UE 115 of FIG. 2 or 3. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 501a-r and antennas 252a-r. Wireless radios 501a-r includes various components and hardware, as illustrated in FIG. 2 for UE 115, including modulator/demodulators 254a-r, MIMO detector 256, receive processor 258, transmit processor 264, and TX MIMO processor 266.

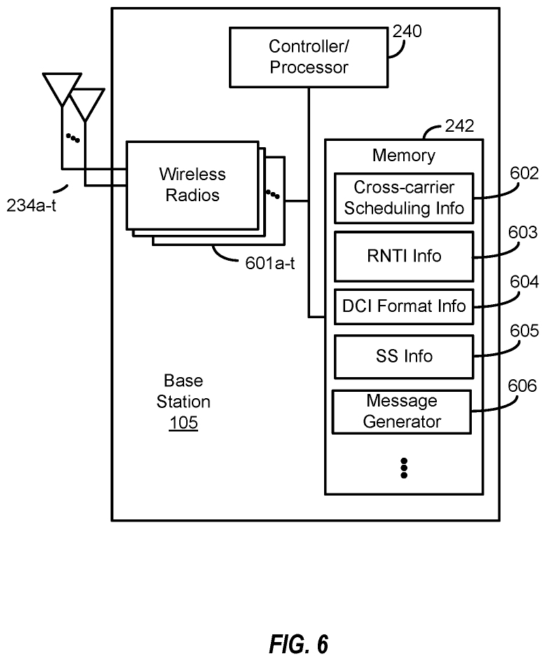

As shown, memory 282 may include one or more conditions 502, RNTI information 503, DCI format information 504, SS information 505, a bandwidth detector 506, a cross-carrier scheduler 507, and a PDCCH monitor 508. The one or more conditions 502, RNTI information 503, DCI format information 504, SS information 505 may include or correspond to one or more conditions 306, RNTI information 308, DCI format information 310, SS information 311, respectively. Bandwidth detector 506, cross-carrier scheduler 507, and PDCCH monitor 508 may include or correspond to bandwidth detector 320, cross-carrier scheduler 322, and PDCCH monitor 323, respectively. In some aspects, bandwidth detector 506, or a combination thereof, may include or correspond to processor(s) 302. UE 115 may receive signals from and/or transmit signal to a base station, such as base station 105, 305 or base station 105 as illustrated in FIG. 6.

Referring to FIG. 4, a sample flow diagram of a method 400 of UE operations for communication is shown. As illustrated at block 401, a UE determines whether one or more conditions is satisfied. The one or more conditions may include or correspond to condition(s) 502. UE may determine the one or more conditions are satisfied using bandwidth detector 506 and/or based on a network message from a network (e.g., 103). In some implementations, UE 115 may transmit the capability information using wireless radios 501a-r and antennas 252a-r.

At block 402, the UE performs physical downlink control channel (PDCCH) monitoring associated with a first cell based on a determination that the one or more conditions is satisfied. The first cell may include a primary cell or a secondary cell. It is noted that the primary cell may include a primary cell of a master cell group (MCG) or a primary secondary cell of a secondary cell group (SCG). In some implementations, UE 115 may receive (or monitor for), from base station 105, 305, one or more PDCCH messages using wireless radios 501a-r and antennas 252a-r. Performing the PDCCH monitoring based on the determination reduces PDCCH monitoring of the first cell for carrier aggregation. For example, the PDCCH monitoring of the first cell may be reduced by performing the PDCCH monitoring, based on the determination, for a second cell.

In some implementations, method 400 may include determining, at the UE, that a first condition of the one or more conditions (e.g., 502) is satisfied with respect to at least one serving cell. The at least one serving cell may include or correspond to a primary cell or a secondary cell, such as first base station 105 or second base station 305. The first condition being satisfied may correspond to the at least one serving cell overlapping a dynamic spectrum sharing (DSS) bandwidth. In some implementations, UE 115 may determine that the at least one service cell overlaps the DSS using bandwidth detector 506.

Based on the first condition being satisfied, the UE may disable cross-carrier scheduling of data in another cell by one or more PDCCHs received in the at least one serving cell. Disabling the cross-carrier scheduling may occur independent of network signaling, such as network message 383. In some implementations, UE 115 may disable cross-carrier scheduling using cross-carrier scheduler 507.

In some implementations, method 400 may include determining, at the UE, that a second condition of the one or more conditions (e.g., 502) is satisfied. The first cell may include a primary cell or a secondary cell. The second condition being satisfied may correspond to the first cell overlapping the DSS bandwidth. In some implementations, UE 115 may determine that the first cell overlaps the DSS using bandwidth detector 506.

Based on the second condition be satisfied, the UE may use cross-carrier scheduling based on PDCCH from a second cell to schedule data for the first cell. In some implementations, the second cell does not overlap the DSS bandwidth. The PDCCH from the second cell may include non-fallback downlink control information (DCI), such as DCI associated with DCI format 1_1 or 0_1. In some implementations, UE 115 may use cross-carrier scheduler 507 for cross-carrier scheduling based on PDCCH from the second cell.

In some implementations, when the first cell includes the second cell and based on the second condition being satisfied, one or more fallback DCIs associated with DCI format 1_0 or 0_0 for the first cell may be received in the first cell. Additionally, or alternatively, when the first cell comprises the primary cell and based on the second condition being satisfied, one or more fallback DCIs for the first cell and one or more other DCIs for the first cell may be received in the first cell. In some such implementations, the one or more other DCIs for the first cell are distinct from non-fallback DCIs for the first cell.

In some implementations, method 400 may include determining, at the UE, that a third condition of the one or more conditions (e.g., 502) is satisfied. The third condition being satisfied may include a first cell overlapping the DSS bandwidth. The first cell may include or correspond to a primary cell. In some implementations, UE 115 may determine that the first cell overlaps the DSS using bandwidth detector 506.

Based on the third condition being satisfied, the UE may monitor one or more group-common (GC) DCIs of the first cell in a second cell. The one or more GC DCIs include a DCI configured to notify the UE of a slot format, a DCI configured to notify the UE of physical resource block(s) (PRB(s)) and orthogonal frequency division multiplexing (OFDM) symbol(s) where UE may assume no transmission is intended for the UE, a DCI configured to transmit power control (TPC) commands for physical uplink control channel (PUCCH) and physical uplink shared channel (PUSCH), a DCI configured to transmit a group of TPC commands for sounding reference signal (SRS) transmissions, or a combination thereof, as illustrative, non-limiting examples. The second cell may include or correspond to a secondary cell. In some implementations, UE 115 may monitor the one or more CG DCIs using PDCCH monitor 508.

In some implementations, method 400 may include determining, at the UE, that a fourth condition of the one or more conditions (e.g., 502) is satisfied. The fourth condition being satisfied may include the first cell overlapping the DSS bandwidth. The first cell may include or correspond to a primary cell. In some implementations, UE 115 may determine that the first cell overlaps the DSS using bandwidth detector 506.

Based on the fourth condition being satisfied, the UE may monitor one or more fallback DCIs of the first cell in a second cell. The second cell may include or correspond to a secondary cell. The one or more fallback DCIs may include a DCI scrambled by: system information (SI)-radio network temporary identifier (RNTI) for system information block (SIB) reception, random access (RA)-RNTI for random access, temporary cell (TC)-RNTI for random access, or paging (P)-RNTI for paging, as illustrative, non-limiting examples. In some implementations, UE 115 may monitor the one or more fallback DCIs using PDCCH monitor 508.

In some implementations, method 400 may include determining, at the UE, that a fifth condition of the one or more conditions (e.g., 502) is satisfied. The fifth condition being satisfied may include the first cell overlapping the DSS bandwidth. The first cell may include or correspond to a primary cell or a secondary cell. In some implementations, UE 115 may determine that the first cell overlaps the DSS using bandwidth detector 506.

Based on the fifth condition being satisfied, the UE may monitor one or more fallback DCIs for unicast data for the first cell in a second cell. For example, the one or more fallback DCIs may be associated with or include DCI formats 0_0 and 1_0 for unicast data for the first cell. In common search space (CSS) for unicast data scheduling, the one or more fallback DCIs for the unicast data may include a DCI scrambled by: cell (C)-radio network temporary identifier (RNTI), modulation coding scheme (MCS)-C-RNTI, or configured scheduling (CS)-RNTI, as illustrative, non-limiting examples. Additionally, or alternatively, In UE specific search space (USS) for unicast data scheduling, the one or more fallback DCIs for the unicast data comprise a DCI scrambled by: C-RNTI; MCS-C-RNTI; or CS-RNTI, as illustrative, non-limiting examples. In some implementations, UE 115 may monitor the one or more fallback DCIs for unicast data using PDCCH monitor 508.

In some implementations, method 400 may include determining, at the UE, that a sixth condition of the one or more conditions (e.g., 502) is satisfied. The sixth condition being satisfied may include the first cell overlapping the DSS bandwidth. In some implementations, UE 115 may determine that the first cell overlaps the DSS using bandwidth detector 506.

Based on the sixth condition being satisfied, the UE may monitor one or more DCIs configured in common search space (CSS) and/or UE specific search space (USS) for the first cell in a second cell. In some implementations, monitoring the one or more DCIs configured in the CSS and/or the USS for the first cell in the second cell may include monitoring all DCIs configured in the CSS and/or the USS for the first cell in the second cell. In some implementations, UE 115 may monitor the one or more DCIs configured in the CSS and/or the USS for the first cell using PDCCH monitor 508.

In some implementations, a search space set (e.g, 505) associated with one or more DCIs is configured by a network in the second cell. The network may include or correspond to core network 130. Additionally, or alternatively, it is noted that a frequency domain resource assignment field of the one or more DCIs may be determined or identified based on a bandwidth part (BWP) bandwidth of the first cell. In some implementations, the search space set associated with the first cell is configured by the network (e.g., 130) in the first cell, and the second cell for monitoring (by the UE) is determined by the network.

In some implementations, the second cell is explicitly configured by a network based on a search space set configuration for the first cell. To explicitly configure the second cell, the network provides an indication of the second cell or the network reuses a scheduling cell of the first cell via which a cross-carrier scheduling DCI for the first cell was monitored. Alternatively, the second cell may be implicitly determined. For example, the second cell may be determined as: a cell, other than the first cell, having a lowest ID in a cell group associated with the UE, or a cell, other than the first cell, having a lowest ID in a cell group associated with the UE and that does not overlap with a DSS bandwidth.

In some implementations, the at least one condition of the one or more conditions being satisfied is distinct from whether or not the first cell overlaps with the DSS bandwidth. In some such implementation, method 400 includes receiving, at the UE from a network (e.g., 130), an indication of a set of conditions of the one or more conditions that are enabled. Additionally, or alternatively, the indication may identify one or more outcomes, such as one or more DCIs to be monitored in a second cell, based on at least one condition being satisfied. The indication may be included in or correspond to a radio resource control (RRC) message or a DCI. In some implementations, the indication may include one or more values and each value may correspond to a different DCI (e.g., a different DCI format and/or a different RNTI) to enable the UE to monitor for the DCI(s) in the second cell. In some such implementations, UE may include a data structure, such as a mapping table, to enable UE to determine which DCI corresponds to which value.

In some implementations, method 400 may include determining, by the UE, whether the first cell overlaps with the DSS bandwidth. Additionally, or alternatively, the UE may determine a set of conditions of the one or more conditions (e.g., 502) is enabled based on a determination that the first cell overlaps with the DSS bandwidth. Although described as determining a set of conditions, in other implementations, UE may determine a set of one or more DCIs to be monitored (for a first cell) in a second cell. For example, the UE may determine or identify the set of one or more DCIs to be monitored based on a determination that the first cell overlaps with the DSS bandwidth.

In some implementations, a network explicitly configures a search space (SS) set index, a SS type, a radio network temporary identifier (RNTI), or a DCI format associated with one or more DCIs of the first cell that are monitored by the UE in the second cell. The network may include or correspond to core network 130. The SS set index and/or the SS type may include or correspond to SS information 505. The RNTI and the DCI format may include or correspond to RNTI information 503 and DCI format information 504, respectively. Additionally, or alternatively, one or more of the SS set index, the SS type, the RNTI, or the DCI format associated with one or more DCIs of the first cell that are monitored by the UE in the second cell may specified by a standard.

In some implementations, method 400 may include receiving, by the UE, at least one fallback DCI for unicast data for the first cell in the second cell and at least one fallback DCI for unicast data for a third cell in the second cell and the third cell can the same cell or different cell as the second cell. The at least one fallback DCI may be scrambled by cell (C)-RNTI, modulation coding scheme (MCS)-C-RNTI, or configured scheduling (CS)-RNTI, as illustrative, non-limiting examples. In some such implementations, method 400 also may include determining whether the at least one fallback DCI for unicast data for the first cell in the second cell is ambiguous with at least one fallback DCI for unicast data for the third cell in the second cell and the third cell can the same cell or different cell as the second cell. The at least one fallback DCI is determined to be ambiguous if the UE cannot determine to which cell a decoded version of the at least one fallback DCI belongs. Based on the at least one fallback DCI being ambiguous, the UE may identify the reception of the at least one fallback DCI as erroneous and discard the at least one fallback DCI.

In some implementations, method 400 may include receiving, by the UE, at least one fallback DCI for unicast data for the first cell in the second cell. Method 400 may also include determining whether the at least one fallback DCI is ambiguous. In some such implementations, based on the at least one fallback DCI being ambiguous, UE may select a particular cell to which a decoded version of the at least one fallback DCI belongs or discard the at least one fallback DCI.

In some implementations, method 400 may include receiving, by the UE, at least one fallback DCI for unicast data for the first cell in the second cell. Method 400 may also include determining whether the at least one fallback DCI is ambiguous. In some such implementations, based on the at least one fallback DCI being ambiguous, the UE may select a particular cell to which a decoded version of the at least one fallback DCI belongs. For example, the particular cell may be selected: as the first cell, as a PCell, based on a value of a cell ID, or based on a SS type.

In some implementations, method 400 may include receiving, by the UE, at least one fallback DCI for unicast data for the first cell in the second cell. Method 400 may also include determining whether the at least one fallback DCI is ambiguous. In some such implementations, based on the at least one fallback DCI being ambiguous, the UE may select a particular cell to which a decoded version of the at least one fallback DCI belongs based on a value included in at least one field added by the network in the DCI format of the at least one fallback DCI.

It is noted that one or more blocks (or operations) described with reference to FIG. 5 may be combined with one or more blocks (or operations) of another of figure. For example, one or more blocks of FIG. 4 may be combined with one or more blocks (or operations) of another of FIG. 2 or 3. Additionally, or alternatively, one or more operations described above with reference to FIGS. 1-3 may be combine with one or more operations described with reference to FIG. 5.

FIG. 6 is a block diagram conceptually illustrating an example design of a base station 105 configured to configure UE 115 to perform predictive CSI estimation according to some embodiments of the present disclosure. FIG. 6 may include or correspond to base station(s) 105, 305 of FIG. 3.

Base station 105 includes the structure, hardware, and components as illustrated for base station 105 of FIG. 2 or 3. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 601a-t and antennas 234a-t. Wireless radios 601a-t includes various components and hardware, as illustrated in FIG. 2 for base station 105, including modulator/demodulators 232a-t, transmit processor 220, TX MIMO processor 230, MIMO detector 236, and receive processor 238. As shown, memory 242 may include cross-carrier scheduling information 602, RNTI information 603, DCI format information 604, SS information 605, and a message generator 606. Cross-carrier scheduling information 602, RNTI information 603, DCI format information 604, SS information 605 may include or correspond to cross-carrier scheduling information 338, RNTI information 308, DCI format information 310, SS information 311, respectively. Message generator 606 may include or correspond to message generator 342. In some aspects, message generator 606 may include or correspond to processor(s) 302. Base station 105 may receive signals from and/or transmit signal to a UE, such as UE 115 as illustrated in FIG. 5.

It is noted that one or more blocks (or operations) described with reference to FIG. 6 may be combined with one or more blocks (or operations) of another of figure. For example, one or more blocks of FIG. 6 may be combined with one or more blocks (or operations) of another of FIG. 2 or 3. Additionally, or alternatively, one or more operations described above with reference to FIGS. 1-3 may be combine with one or more operations described with reference to FIG. 6.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 1-6 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining, by a user equipment (UE), whether one or more conditions is satisfied; and
performing, by the UE, physical downlink control channel (PDCCH) monitoring associated with a first cell based on a determination that the one or more conditions is satisfied.

2. The method of claim 1, wherein performing the PDCCH monitoring based on the determination reduces PDCCH monitoring of the first cell for carrier aggregation.

3. The method of claim 2, wherein the PDCCH monitoring of the first cell is reduced by performing the PDCCH monitoring, based on the determination, for a second cell.

4. The method of claim 1, wherein the first cell comprises a primary cell or a secondary cell.

5. The method of claim 4, wherein the primary cell comprises a primary cell of a master cell group (MCG) or a primary secondary cell of a secondary cell group (SCG).

6. The method of claim 1, further comprising:
determining, at the UE, that a first condition of the one or more conditions is satisfied with respect to at least one serving cell; and
disabling, by the UE based on the first condition being satisfied, cross-carrier scheduling of data in another cell by one or more PDCCHs received in the at least one serving cell.

7. The method of claim 6, wherein the first condition being satisfied comprises the at least one serving cell overlapping a dynamic spectrum sharing (DSS) bandwidth.

8. The method of claim 6, wherein the least one serving cell comprises the first cell, a primary cell, or a secondary cell.

9. The method of claim 6, wherein disabling the cross-carrier scheduling occurs independent of network signaling.

10. The method of claim 1, further comprising:
determining, at the UE, that a second condition of the one or more conditions is satisfied; and
using, by the UE based on the second condition being satisfied, cross-carrier scheduling based on PDCCH from a second cell to schedule data for the first cell.

11. The method of claim 10, wherein the second condition being satisfied comprises the first cell overlapping a dynamic spectrum sharing (DSS) bandwidth.

12. The method of claim 10, wherein the first cell comprises a primary cell or a secondary cell.

13. The method of claim 10, wherein:
the PDCCH from the second cell comprises non-fallback downlink control information (DCI) associated with DCI format 1_1 or 0_1; and
the second cell does not overlap the DSS bandwidth.

14. The method of claim 10, wherein, based on the second condition being satisfied:
when the first cell comprises the second cell, one or more fallback DCIs associated with DCI format 1_0 or 0_0 for the first cell are received in the first cell; and
when the first cell comprises the primary cell, one or more fallback DCIs for the first cell and one or more other DCIs for the first cell are received in the first cell, the one or more other DCIs for the first cell distinct from non-fallback DCIs for the first cell.

15. An apparatus configured for wireless communication, the apparatus comprising:
at least one processor; and
a memory coupled to the at least one processor,
wherein the at least one processor is configured to:
determine, by a user equipment (UE), whether one or more conditions is satisfied; and
perform, by the UE, physical downlink control channel (PDCCH) monitoring associated with a first cell based on a determination that the one or more conditions is satisfied.

16. The apparatus of claim 15, wherein performing the PDCCH monitoring based on the determination reduces PDCCH monitoring of the first cell for carrier aggregation.

17. The apparatus of claim 16, wherein the PDCCH monitoring of the first cell is reduced by performing the PDCCH monitoring, based on the determination, for a second cell.

18. The apparatus of claim 15, wherein the first cell comprises a primary cell or a secondary cell.

19. The apparatus of claim 18, wherein the primary cell comprises a primary cell of a master cell group (MCG) or a primary secondary cell of a secondary cell group (SCG).

20. The apparatus of claim 15, wherein the at least one processor is further configured to:
determine, at the UE, that a first condition of the one or more conditions is satisfied with respect to at least one serving cell; and
disable, by the UE based on the first condition being satisfied, cross-carrier scheduling of data in another cell by one or more PDCCHs received in the at least one serving cell.

21. The apparatus of claim 20, wherein the first condition being satisfied comprises the at least one serving cell overlapping a dynamic spectrum sharing (DSS) bandwidth.

22. The apparatus of claim 20, wherein the least one serving cell comprises the first cell, a primary cell, or a secondary cell.

23. The apparatus of claim 20, wherein disabling the cross-carrier scheduling occurs independent of network signaling.

24. The apparatus of claim 15, wherein the at least one processor is further configured to:
determine at the UE, that a second condition of the one or more conditions is satisfied; and
use, by the UE based on the second condition being satisfied, cross-carrier scheduling based on PDCCH from a second cell to schedule data for the first cell.

25. The apparatus of claim 24, wherein the second condition being satisfied comprises the first cell overlapping a dynamic spectrum sharing (DSS) bandwidth.

26. The apparatus of claim 24, wherein the first cell comprises a primary cell or a secondary cell.

27. The apparatus of claim 24, wherein:
the PDCCH from the second cell comprises non-fallback downlink control information (DCI) associated with DCI format 1_1 or 0_1; and
the second cell does not overlap the DSS bandwidth.

28. The apparatus of claim 24, wherein, based on the second condition being satisfied:
when the first cell comprises the second cell, one or more fallback DCIs associated with DCI format 1_0 or 0_0 for the first cell are received in the first cell; and
when the first cell comprises the primary cell, one or more fallback DCIs for the first cell and one or more other DCIs for the first cell are received in the first cell, the one or more other DCIs for the first cell distinct from non-fallback DCIs for the first cell.

29. A non-transitory computer-readable medium having program code recorded thereon, the program code comprising:
program code executable by a computer for causing the computer to:
determine, by a user equipment (UE), whether one or more conditions is satisfied; and
perform, by the UE, physical downlink control channel (PDCCH) monitoring associated with a first cell based on a determination that the one or more conditions is satisfied.

30. An apparatus configured for wireless communication, comprising:
means for determining, by a user equipment (UE), whether one or more conditions is satisfied; and
means for performing, by the UE, physical downlink control channel (PDCCH) monitoring associated with a first cell based on a determination that the one or more conditions is satisfied.
